(19) United States
(12) Patent Application Publication
(10) Pub. No.: US 2025/0371876 A1
(43) Pub. Date: Dec. 4, 2025

(54) ROBUST AND CONSISTENT VIDEO INSTANCE SEGMENTATION

(71) Applicant: Adobe Inc., San Jose, CA (US)

(72) Inventors: Joon-Young Lee, San Jose, CA (US); Seoung Wug Oh, San Jose, CA (US); Miran Heo, Seoul (KR)

(73) Assignee: Adobe Inc., San Jose, CA (US)

(21) Appl. No.: 18/680,579

(22) Filed: May 31, 2024

(51) Int. Cl. G06V 20/40; G06V 10/62; G06V 10/70

(52) U.S. Cl. CPC G06V 20/49; G06V 10/62; G06V 10/768; G06V 20/46

(57) ABSTRACT

Embodiments are disclosed for performing video instance segmentation to mask objects across frames of a video. The method may include obtaining a frame of a video sequence where the frame depicts an object. The method further includes determining a calibrated feature of the frame using temporal information associated with a past frame. The method further includes determining a pixel embedding using the calibrated feature. The method further includes determining an object token using a past object token associated with the past frame and the pixel embedding. The method further includes generating a masked frame using the object token and the pixel embedding. The masked frame includes a masked object corresponding to the object.

### BACKGROUND

Instance segmentation is a technique used to classify pixels in an image as belonging to a particular object. In this manner, particular instances of objects of an image are delineated from other objects of the image. The segmented instances of objects can be displayed as masked objects in a frame of a video. The segmented instances of objects are propagated through each frame of the multiple frames included in a video using object masks.

### SUMMARY

Introduced here are techniques/technologies that perform video instance segmentation to mask objects across frames of a video. The segmentation system leverages the temporal context of objects at a dense pixel-level to improve the accuracy and consistency of mask predictions across video frames. The segmentation system combines object-level knowledge with dense pixel embeddings to determine mask output predictions and mask classes.

More specifically, in one or more embodiments, the segmentation system uses residual connections to pass information about a current frame of a video sequence to previous frames in the video sequence. Accordingly, memory of past objects in a frame, past features of the frame, and the background of the past frame improves the segmentation system's ability to segment objects at the instance-level by providing object-level contextual information to the segmentation system. Accordingly, features determined by the segmentation are calibrated across frames of the video, thereby making such features frame-dependent. The calibration of features of the frame, before the generation of per-pixel embeddings of the frame, improves object-level predictions of the current frame. Additionally, residual connections pass past objects of a frame to a decoder of the segmentation system to improve the segmentation system's ability to segment objects at the pixel-level.

Additional features and advantages of exemplary embodiments of the present disclosure will be set forth in the description which follows, and in part will be obvious from the description, or may be learned by the practice of such exemplary embodiments.

### BRIEF DESCRIPTION OF THE DRAWINGS

The detailed description is described with reference to the accompanying drawings in which:

FIG. 1 illustrates a diagram of a process of segmenting an object in a frame in accordance with one or more embodiments;

FIG. 2 illustrates a diagram of an instance mask propagation manager, in accordance with one or more embodiments;

FIG. 3 illustrates a diagram of a direct query decoding manager, in accordance with one or more embodiments;

FIG. 4 illustrates an example process of supervised learning used to train the segmentation system in an end-to-end approach, in accordance with one or more embodiments;

FIG. 5 illustrates a schematic diagram of a segmentation system in accordance with one or more embodiments;

FIG. 6 illustrates a flowchart of a series of acts in a method of performing video instance segmentation to mask objects across frames of a video, in accordance with one or more embodiments; and

FIG. 7 illustrates a block diagram of an exemplary computing device in accordance with one or more embodiments.

### DETAILED DESCRIPTION

One or more embodiments of the present disclosure includes a segmentation system that leverages the temporal context of objects at a dense pixel-level scale to improve the accuracy and consistency of object instance mask predictions across video frames. In conventional approaches, tracking by detection methods of video instance segmentation bridge image segmentation models with association techniques to temporally track objects across frames of the video. Conventional tracking by detection methods generate object proposals independently from each frame and match the object proposals across frames. However, the tracking by detection methods cause segmentation results that lack consistency at the pixel-level and instance level. Pixel-level inconsistencies across frames of the video cause inconsistent mask determinations. Such inconsistent mask determinations cause objects that should not be classified as a single object to erroneously be classified as a single object, overlapping predictions of objects, and/or incomplete mask predictions of an object (e.g., an object in a frame is not masked completely). More generally, pixel-level inconsistencies can cause low quality mask predictions. Additionally or alternatively, pixel-level inconsistencies may cause a temporal jittering of masks.

Instance-level inconsistencies cause objects that should not be masked to be masked. That is, an object is masked that does not fall within a predefined list of objects to be masked. For example, portions of a background can be erroneously masked. More generally, instance-level inconsistencies produce redundant mask predictions (e.g., false positives) or instance ID switching. The limitations of tracking by detection methods of video instance segmentation can be traced to, in part, the decoupled approach involving the independent generation of mask proposals across frames and the association of such temporally discretized outputs. For example, conventional tracking by detection methods may identify erroneous object masks given a complex trajectory of the object across frames of the video based on a lack of temporal information across frames.

In another conventional approach, joint detection and tracking methods of video instance segmentation methods employ transformer-based architectures to aggregate spatio-temporal features across multiple frames using self-attention. Some conventional joint detection and tracking methods compute pixel correlations within a window of a frame and encode the pixel correlations of the window using spatio-temporal aggregation. Other conventional joint detection and tracking methods embed spatial information in a frame-independent manner and decode the spatial information using temporal information. However, the joint detection and tracking methods do not consider the context of objects and more generally, lack object-level knowledge.

To address these and other deficiencies in conventional systems, the segmentation system of the present disclosure integrates object-level knowledge into dense pixel embeddings using a joint detect and track method to perform video instance segmentation. The segmentation system leverages the temporal context of objects at a dense pixel-level scale to improve the accuracy and consistency of mask predictions across video frames. Object-level knowledge is fused into dense pixel embeddings when determining mask output predictions and mask classes. The mask output predictions and mask classes associated with a frame represent particular masked objects of the frame.

Improving the accuracy of mask predictions reduces computing resources that would otherwise be consumed correcting inaccurate mask predictions. For example, video editing software resources are not consumed fixing or otherwise adjusting inaccurate mask predictions. Additionally or alternatively, the improved accuracy of mask predictions, using robust and consistent video instance segmentation, reduces computing resources that would otherwise be consumed re-running conventional segmentation systems that generate inaccurate mask predictions. The segmentation system of the present disclosure performs video instance segmentation less often, as a result of more accuracy mask predictions, conserving power, bandwidth, memory, and other computing resources.

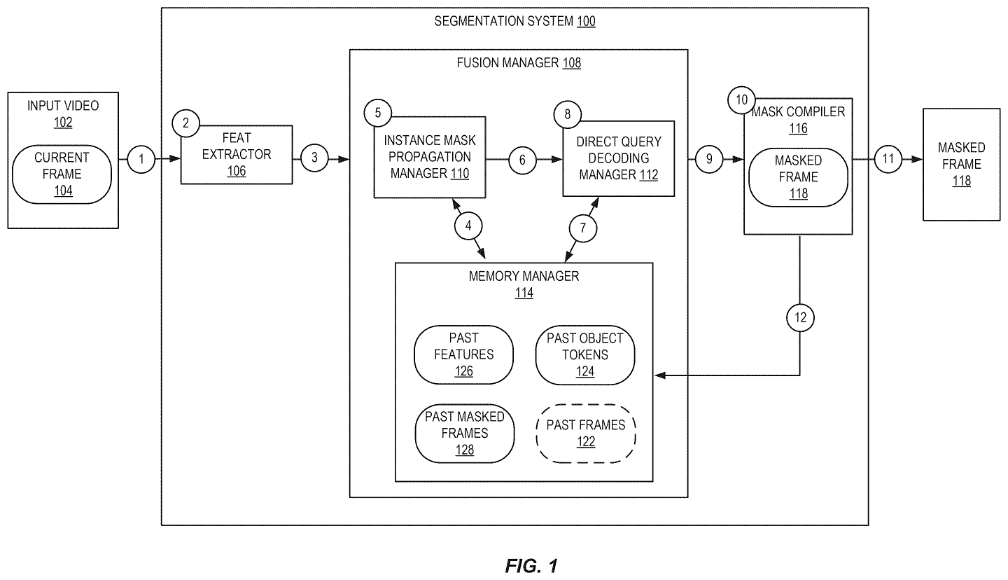

FIG. 1 illustrates a diagram of a process of segmenting an object in a frame, in accordance with one or more embodiments. The segmentation system 100 segments particular object of a frame (e.g., instances of the frame) using memory of the segmented objects in previous frames of the video sequence. The segmentation system 100 can be implemented as a standalone system and/or incorporated as part of a larger system or application. The object, once segmented by the segmentation system 100, is masked to create a masked frame including the object. The object of the frame is a representation of an object depicted in or by the frame.

At numeral 1, a current frame 104 of an input video 102 is received by the segmentation system 100. The input video 102 may be a computer-generated video, a video captured by a video recorder (or other sensor), and the like. The input video 102 includes any digital visual media including a plurality of frames which, when played, includes a moving visual representation of a story and/or an event. Each frame of the input video 102 is an instantaneous image of the video. The current frame 104 is the frame at time t processed by the segmentation system 100 and can include an image depicting one or more objects.

After processing by the segmentation system 100, the current frame 104 (e.g., frame at time t) results in a corresponding masked frame 118 at time t. That is, an object is segmented by the segmentation system 100, resulting in masked frame 118 including one or more masked objects corresponding to the one or more objects in the current frame 104. The masked frame 118 associated with the frame at time t may be stored in the memory manager 114 as past masked frame 128 for use during processing of an input frame at a time t+1 (not shown).

At numeral 2, the feature extractor 106 receives the current frame 104 of the input video 102 and determines features F of the current frame 104. Features F of the current frame are a low-resolution latent space representation of the current frame 104 (e.g., frame features). Features F represent mathematically captured characteristics or properties of the current frame 104. The latent space representation is a space in which unobserved features are determined such that relationships and other dependencies of such features can be learned. The latent space representation may be a feature map (otherwise referred to herein as a feature vector) of extracted properties/characteristics of the current frame 104. In some embodiments, the features F of the current frame 104 may be a feature map that encodes appearance and positional information of each object in the current frame 104. In some embodiments, the feature extractor is a neural network such as ResNet.

A neural network may include a machine-learning model that can be tuned (e.g., trained) based on training input to approximate unknown functions. In particular, a neural network can include a model of interconnected digital neurons that communicate and learn to approximate complex functions and generate outputs based on a plurality of inputs provided to the model. For instance, the neural network includes one or more machine learning algorithms. In other words, a neural network is an algorithm that implements deep learning techniques, i.e., machine learning that utilizes a set of algorithms to attempt to model high-level abstractions in data.

At numeral 3, the features F of the current frame 104 are passed to the fusion manager 108. The fusion manager 108 integrates object-level knowledge into dense pixel embeddings using the instance mask propagation manager 110, the direct query decoding manager 112, and memory manager 114. The fusion manager 108 fuses object-level knowledge into dense pixel embeddings to determine masked frame 118, which includes output mask predictions of each particular object in the current frame 104 (e.g., each instance of the current frame 104) and mask classes. The fusion manager 108 leverages the temporal context of objects at a dense pixel-level scale to improve the accuracy and consistency of mask predictions across video frames of the input video 102. It should be appreciated that while memory manager 114 is illustrated as a component within the fusion manager 108, memory manager 114 may be any computing device external to the fusion manager 108 and/or external to the segmentation system 100.

At numeral 4, the memory manager 114 passes past masked frames 128, past features 126, and past object tokens 124 to the instance mask propagation manager 110. As described herein, past masked frames 128 are masked frames 118 including masked objects (e.g., masked representation of each instance of an object) determined at a time before time t if the current frame 104 is a frame of the input video 102 at time t. Past features 126 are feature vectors associated with a frame at a time before t if the current frame is a frame of the input video 102 at time t. Past object tokens 124 are output query embeddings associated with object instances of a past frame 122. In some embodiments, an object token refers to an embedding of an instance of an object in a frame (e.g., a particular object in the frame). An embedding is a high-resolution latent space representation of one or more features. Also at numeral 4, the instance mask propagation manager 110 can store features F of the current frame 104 at time t (e.g., received from the feature extractor 106 at numeral 3) in the memory manager 114 as past features 126 for use during processing of an input frame at time t+1 (not shown).

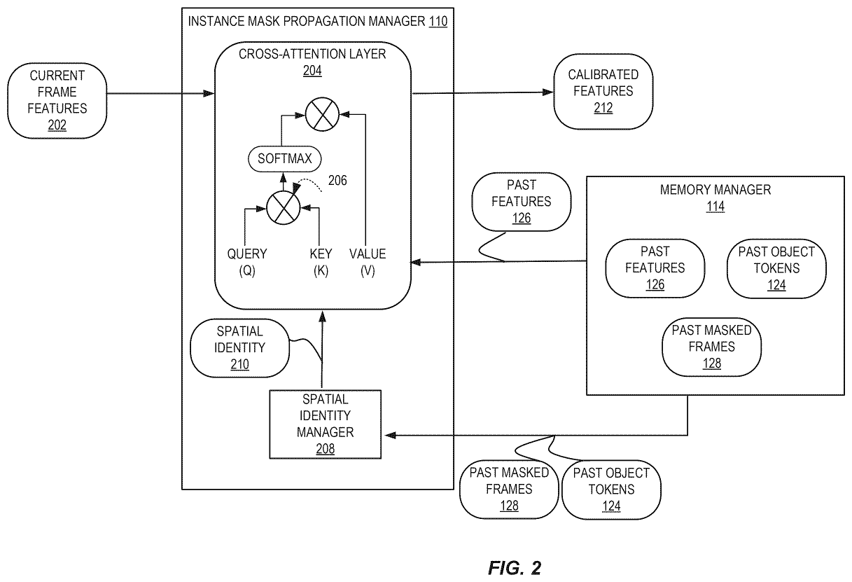

At numeral 5, the instance mask propagation manager 110 fuses or otherwise combines features of the current frame 104 with object-aware sparse embeddings (e.g., using the past masked frames 128, past features 126, and past object tokens 124 received by the memory manager 114) to calibrate features of the current frame 104 with respect to past temporal information. Masked frames from the set of past masked frames 128 can be target conditions for subsequent frames (e.g., current frame 104). As a result of the operations of the instance mask propagation manager 110 performed at numeral 5, features F of the current frame 104 are combined with temporal information at the pixel level to generate calibrated features for the current frame 104. FIG. 2 describes the operations of the instance mask propagation manager 110.

At numeral 6, the instance mask propagation manager 110 passes the calibrated features to the direct query decoding manager 112. At numeral 7, the direct query decoding manager 112 receives past object tokens 124 from the memory manager 114. Also at numeral 7, the object tokens of the current frame 104 at time t, determined by the direct query decoding manager 112, can be stored as past object tokens 124 of the memory manager 114. That is, the memory manager 114 stores object tokens of the current frame 104 at time t such that the object tokens can be input as past object tokens 124 for a subsequent frame at time t+1.

At numeral 8, the direct query decoding manager 112 identifies object tokens of the current frame 104 from a total set of object queries. Both object tokens and object queries can be embeddings. The set of object tokens identified in the current frame 104 is a subset of the object queries. For example, given a number of object queries that may be present in any given frame, object tokens represent the objects that may be present in the current frame 104. In some embodiments, each object token is associated with a particular object of the frame (e.g., an instance of the object in the frame). For example, given three people represented in a frame, a first object token represents a first person represented in the frame, a second object token represents a second person represented in the frame, and a third object token represents a third person represented in the frame. In operation, the direct query decoding manager 112 combines object tokens identified from previous frames (e.g., past object tokens 124 received from the memory manager 114 at numeral 7) with per-pixel embeddings that are based on the calibrated features received by the direct query decoding manager 112 at numeral 6.

At numeral 9, the direct query decoding manager 112 passes a representation of segmented objects of the current frame 104 (e.g., object tokens) to the mask compiler 116. Additionally, the direct query decoding manager 112 passes the per-pixel embeddings that are based on the calibrated features to the mask compiler 116. At numeral 10, the mask compiler 116 creates masked frame 118 that is understandable by humans. For example, the masked frame 118 is a frame that differentiates object instances by masking segmented objects in a way that visually differentiates objects from other objects in the frame.

In some embodiments, the mask compiler 116 generates a probability distribution indicating a likelihood of each pixel of the frame belonging to a mask (e.g., an instance of an object). In an example, a pixel that likely belongs to an object to be masked receives a high likelihood (e.g., a value of 1), and a pixel that likely does not belong to the object to be masked receives a low likelihood (e.g., a value of 0). In operation, the mask compiler 116 convolves the object tokens of the current frame 104 with per-pixel embeddings that are based on the calibrated features to generate the probability distribution.

The mask compiler 116 converts the probabilities of the probability distribution into a mask displayed to a user. For example, the mask compiler 116 overlays a visual indicator over each pixel belonging to the mask. Such overlayed visual indicators may be colors, patterns, and the like. As a result of the overlaid visual indicator(s) determined by the mask compiler 116, the masked frame 118 of the current frame 104 masks object instances included in the current frame 104. At numeral 11, the masked frame 118 is displayed for a user as an output of the segmentation system 100. In other embodiments, the masked frame 118 is communicated to one or more processing devices for subsequent processing.

At numeral 12, the mask compiler 116 passes the masked frame 118 to the memory manager 114. In some embodiments, the mask compiler 116 passes the probability distribution that indicates the likelihood of each pixel of the current frame 104 belonging to a mask as masked frame 118. In some embodiments, the mask compiler 116 passes the object tokens identified in the current frame 104 as masked frame 118.

Over time, the memory manager 114 can accumulate past frames 122 and past masked frames 128. For example, current frame 104 and corresponding masked frame 118 at time t may become a past frame 122 and corresponding past masked frames 128 at time t+1. In some embodiments, the memory manager 114 does not store past frames 122. Past masked frames of the set of past masked frames 128 are past frames 122 that have been segmented, resulting in masked objects in the frame.

In some embodiments, the memory manager 114 algorithmically combines (e.g., averages, etc.) one or more past frames to determine the set of past frames 122 and/or masks of the set of past masked frames 128. In other embodiments, memory manager 114 selects frames and masks to become part of the set of past frames 122 and the set of past masked frames 128 that satisfy one or more criteria. For example, frames and masks that satisfy a temporal threshold are stored as past frames 122 and past masked frames 128. Specifically, the memory manager 114 may compare a location of pixels of a past frame to the corresponding location of the pixels in a candidate frame (a frame being evaluated by the memory manager 114 as potentially being added to the set of past frames 122). If the location of one or more pixels between the past frame and candidate frame are within a threshold distance, then the memory manager 114 determines that the candidate frame and past frame are temporally related. In some embodiments, the memory manager 114 performs the above evaluation on a candidate mask (e.g., a mask being evaluated by the memory manager 114 as a mask that may be added to the collection of past masked frames 128). In some embodiments, responsive to determining that the candidate frame is temporally related to a past frame 122, the memory manager 114 determines that the corresponding candidate mask is temporally related to a past masked frame of the past masked frames 128.

In some embodiments, the memory manager 114 maintains a number of past frames 122 and past masked frames 128. For example, the memory manager 114 stores N most recent past frames 122 and past masked frames 128. In other embodiments, the memory manager 114 accumulates and stores every past frame and past masked frame in the set of past frames 122 and past masked frames 128 respectively.

FIG. 2 illustrates a diagram of the instance mask propagation manager, in accordance with one or more embodiments. As described herein, the instance mask propagation manager 110 calibrates features across frames before the per-pixel embeddings are determined using the direct query decoding manager 112. In operation, the instance mask propagation manager 110 receives features from the feature extractor 106 (e.g., current frame features 202) and combines the features with past features 126 and an augmented version of the past features 126.

The memory manager 114 passes past masked frames 128 and the past object tokens 124 to the spatial identity manager 208. Advantageously, past masked frames 128 include more contextual information than a feature-level representation of the masked objects. Additionally, past object tokens 124 provide pixel-level information of a past masked frame. Accordingly, the calibrated features 212, determined by the instance mask propagation manager 110, leverage object-aware, pixel-level knowledge from previous frames based on the cross-attention of the current frame features 202 with the spatial identity 210 of objects in previous frames (e.g., temporal information).

As described herein, object tokens are determined by the direct query decoding manager 112 to represent objects identified in a current frame (e.g., query embeddings). The object tokens are stored in the memory manager 114 as past object tokens 124 for processing of a subsequent frame. As a result, the past object tokens 124 used by the instance mask propagation manager 110 include temporal object information from previous frames in the video sequence. Accordingly, the calibrated features 212 are not frame-independent (e.g., frame dependent), improving the object token predictions determined by the direct query decoding manager 112 at the pixel-level, which increases pixel-level consistency of object masks across frames. Accordingly, passing one or more past masked frames 128, in addition to past object tokens 124, to the instance mask propagation manager 110 can improve object coherency across frames of the video.

The spatial identity manager 208 encodes object tokens into their respective spatial regions. In other words, the spatial identity of objects of past frames Zₜ₋₁ can be defined using a past masked frame Mₜ₋₁ and past object tokens Qₜ₋₁. Mathematically, the spatial identity of the objects in past frame can be represented according to Equation (1) below:

$${Z}_{t - 1} = {Q}_{t - 1} \cdot {M}_{t - 1} where {Z}_{t - 1} ∈ {ℝ}^{C \times H \times W} , {M}_{t - 1} ∈ {[ 0 , 1 ]}^{N \times H \times W} , {Q}_{t - 1} ∈ {ℝ}^{N \times C} \qquad ( 1 )$$

In Equation (1) above, the dimensions of the t−1 frame are H×W, the number of objects in the tₜₕ frame are C, and N represents the number of regions of a frame if the frame is partitioned into one or more regions.

The spatial identity manager 208 also encodes the background of the past frame (e.g., regions of the frame without a detected object). That is, while the past object tokens 124 and past masked frames 128 represent objects and the locations of objects identified in a past frame, the background of the past frame is determined by the spatial identity manager 208. The spatial identity of the objects and background of the past frame is

$${Z}_{t - 1}^{′} ,$$

defined according to the spatial identity of the objects of the past frame Zₜ₋₁ and the background (e.g., any pixels that are not assigned to a foreground object). Mathematically, this is represented according to Equation (2) below:

$${Z}_{: , h , w}^{′} = {Z}_{: , h , w} + B \times 1 \{ {\sum }_{c = 1}^{C} {Z}_{c , h , w} = 0 \} , ∀ ( h , w ) \qquad ( 2 )$$

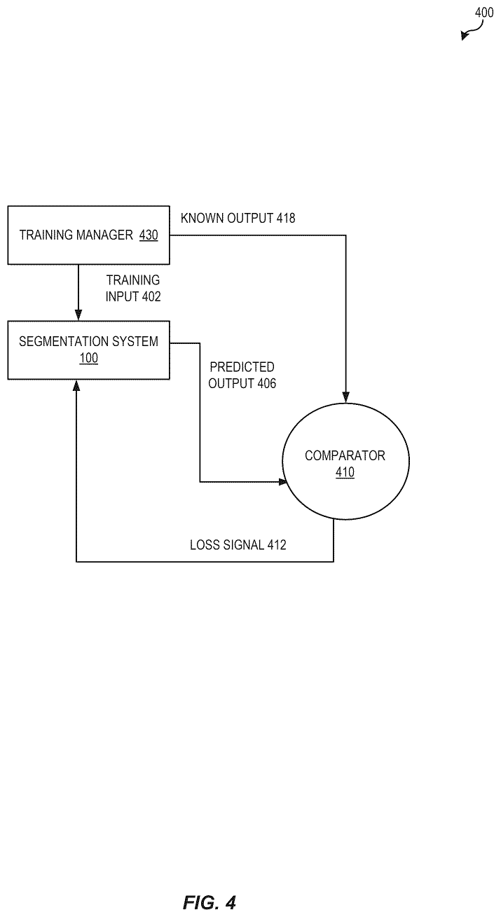

In Equation (2) above, B represents a learnable vector that is filled with a value of “1” for each pixel in the past frame that is not assigned an object token. Training the learnable vector B is described in FIG. 4. The spatial identity manager 208 passes the spatial identity 210 (e.g., the spatial identity of the objects and the background of the past frame,

$${Z}_{t - 1}^{′} )$$

to the cross-attention layer 204.

The cross-attention layer 204 attends two different inputs, namely the features determined from the feature extractor 106 (e.g., current frame features 202) and the spatial identity 210 of the past frame

$$( e . g . , {Z}_{t - 1}^{′} ) ,$$

determined using the spatial identity manager 208. Because the spatial identity 210 is determined using past masked frames 128 and past object tokens 124, the current features 202 include temporal information. As a result, the cross-attention layer 204 captures the correlations between the current frame features 202 and the past features 126 with temporal information carried by the spatial identity 210.

The query vector space Q of the cross-attention layer 204 is used to identify features of the current frame that should be attended using a query weight matrix W_{Q} and linear map of current frame features 202 (represented as “X” in Equation (3) below). Equation (3) below represents the query vector space mathematically:

$$Q = X {W}_{Q}^{T} \qquad ( 3 )$$

The current frame features 202 are mixed with the past features 126 received from the memory manager 114 using the key vector space of the cross-attention layer. The key vector space K is used to identify the past features 126 that are related to the query using a key weight matrix W_{K} and the linear map of the past features 126 (represented as “Y” in Equation (4)). In some embodiments, the key vector space is based on a number of past features 126. For example, the key vector space is based on the past five features. In some implementations, the past features 126 across multiple frames are concatenated to enrich the temporal information. Equation (4) below represents the key vector space mathematically:

$$K = Y {W}_{K}^{T} \qquad ( 4 )$$

The relationship of the current frame features 202 and the past features 126 can be determined using the dot product of the query vector space and the key vector space for instance, to determine a similarity of the features in the previous frame (e.g., past features 126) and the features of the current frame (e.g., current frame features 202). Equation (5) below represents the mathematical operations at 206 and includes two linear maps

$$( e . g . , {x}_{i}^{T} {W}_{Q} and {W}_{K}^{T} {y}_{j} ) .$$

$${P}_{i , j} = {x}_{i}^{T} {W}_{Q} {W}_{K}^{T} {y}_{j} , ∀ i , j ∈ \{ 1 , … , n \} \qquad ( 5 )$$

In some embodiments, processing can be performed on the output matrix P. For example, the values in the output matrix P determined at 206 can be normalized. The softmax function is used to obtain the attention weights by emphasizing higher values in the output matrix P and diminishing lower values in the output matrix P. The softmax function is a normalized exponential function that transforms an input of real numbers into a normalized probability distribution over features (e.g., current frame features 202 and past features 226).

The value vector space V of the cross-attention layer 204 is used to attend the spatial identity 210 (which captures the spatial identity of objects in a past frame and the background of the past frame) with the current frame features and past frame features using a value weight matrix W_{V} and the linear map of S. S represents the past features 126 augmented with the spatial identity 210. In some embodiments, the value vector space is based on a number of past features 126 augmented with the corresponding spatial identity 210. For example, the value vector space is based on the past five features augmented with the corresponding past five spatial identities. In some implementations, past features and corresponding spatial identities across a number of frames are concatenated to enrich the temporal information. Equation (6) below represents the augmentation of past features 126 with spatial identity 210 mathematically (e.g., the value vector space):

$$V = S {W}_{V}^{T} S = {F}_{t - 1} + {Z}_{t - 1}^{′} \qquad ( 6 )$$

When the instance mask propagation manager 110 processes the first frame of the input video 102 (e.g., a frame at time t=0), the query vector space, key vector space, and value vector space are modified. For example, the query vector space can include the features of the first frame, the key vector space can include the features of the first frame, and the value vector space can include a tensor E∈ [symbol] ^{C,H,W} of B at all pixel coordinates augmented with the features of the first frame.

The output of the cross-attention layer 204 are calibrated features 212, which are determined using the dot product of the output of the softmax function and the value vector space. As described herein, the calibrated features 212 are passed to the direct query decoding manager 112 of the fusion manager 108. The calibrated features 212 are used to calibrate the per-pixel embeddings determined by the direct query decoding manager 112 of the fusion manager 108 using object-aware information from previous sequences (e.g., the spatial identity 210 and the past features 126).

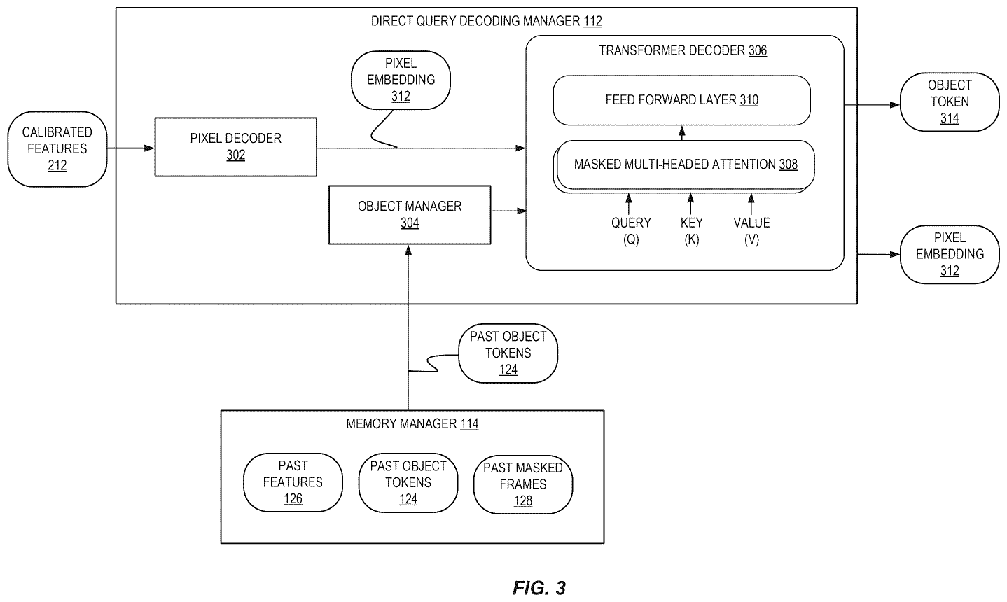

FIG. 3 illustrates a diagram of the direct query decoding manager, in accordance with one or more embodiments. The direct query decoding manager 112 combines past object token information with pixel embeddings fused with temporal information to increase the ability of the direct query decoding manager 112 to detect object tokens in a current frame.

The pixel decoder 302 receives the calibrated features 212 from the instance mask propagation manager 110. As described herein, calibrated features 212 include temporal information from previous frames. The pixel decoder 302 can be any machine learning model configured to upscale the low-resolution calibrated features 212 into high-resolution pixel embeddings (e.g., per-pixel embeddings). Accordingly, the pixel decoder 302 transforms the calibrated features 212 into per-pixel embeddings that leverage the temporal information of the calibrated features 212.

The object manager 304 receives past object tokens 124 from the memory manager 114. The object manager 304 assigns a unique object ID to each past object token 124 such that the identity of objects is preserved across frames of the input video 102. In operation, the object manager 304 uses the index of each object query as the object's identity. For example, given 100 object queries that are propagated through the video, the indices (0-99) are assigned each object's identity since each object is associated with the same instance of the object. That is, the constraint that each object query is used to predict the same object instance across frames of the video allows for indices of objects to be used as the object's identity. As a result, past object tokens 124 are directly propagated to the transformer decoder 306 to be used to predict object tokens 314 of the current frame. In some embodiments, the object token 314 determined by the transformer decoder 306 is biased towards the past object tokens 124. The operations of the object manager 304 differ from methods that assign object queries to any object on a frame-by-frame basis.

Unlike conventional systems that may pass object tokens based on frame-level object tokens to a transformer decoder, the object tokens passed to the transformer decoder 306 by the object manager 304 are based on the pixel embeddings determined by the pixel decoder 302. That is, because the object tokens 314 determined by the transformer are based on pixel embeddings 312, which are based on calibrated features 212, the object tokens stored in the memory manager as past object tokens 124 include temporal information. Passing only frame-level features to the transformer decoder 306 may improve coherency at the object-level (e.g., object-level tracking). However, passing the pixel embeddings to the transformer decoder 306, along with past object tokens 124, improves coherency at the pixel-level. The attention performed by the transformer decoder 306 allows the propagated object embedding (e.g., past object tokens 124) to reference the pixel embeddings 312 of the current frame.

Improving coherency at the pixel-level reduces pixel-level inconsistencies and instance-level inconsistencies. As described herein, the pixel embeddings are based on the calibrated features 212 such that the object detection performed by the transformer decoder 306 is directly influenced by temporal information.

The transformer decoder 306 combines object-aware sparse embeddings (e.g., past object tokens 124) with pixel embeddings 312 to enhance the pixel decoding processing. In operation, the transformer decoder 306 transforms the pixel embeddings into frame-level object queries (e.g., object tokens 314) using the unique object ID of past object tokens 124. The output of the transformer decoder 306 includes object tokens 314, which can be mathematically represented according to Equation (6) below:

$${Q}_{t} = D ( {Q}_{t - 1} , P ( {F}_{t} ) ) \qquad ( 6 )$$

In Equation (6) above, for the tₜₕ frame of a video, Qₜ₋₁ represents the past object tokens 124 (e.g., output query embeddings of a previous frame), Qₜ represents the object tokens 314 (e.g., output query embedding for the current frame at time t), D represents the transformer decoder 306, P represents the pixel decoder 302, and Fₜ represents the calibrated features 212 for the current frame at time t.

Unlike conventional methods, in which a transformer decoder uses frame-level object queries (e.g., by parsing an image using object queries at the frame-level), the transformer decoder 306 uses the pixel-level embeddings determined from the pixel decoder 302 decoding the calibrated features 212. Accordingly, the object queries for the current frame at time t (e.g., Qₜ) refer to pixel-level embeddings instead of frame-level object embeddings, enhancing the mask prediction ability of the direct query decoding manager 112.

The transformer decoder 306 includes one or more masked multi-headed attention blocks 308 and one or more feed forward blocks 310. While shown as a masked multi-headed attention block 308, it should be appreciated that the transformer decoder 306 can include a single headed masked attention block.

In the masked multi-headed attention block 308, each head receives a linearly projected version of the query, key, and value vectors, and produces an output to be fed to the feed forward block 310 in parallel. In general, masked attention is used to mask subsequent elements in the query, key, and/or value vectors to prevent elements of a vector from attending to subsequent elements. As a result, elements of the query, key, and/or value vectors are independently attended.

The output of each head weighs elements of the vector spaces (Q, K, and V). In multi-headed attention, the output of the heads are concatenated and multiplied by a weight matrix W_{O}. The weight matrix W_{O} represents the algorithmic combination of different heads learning different information about the frame at time t. The feed forward block 310 can be any neural network model that applies non-linear transformations to the output of the masked multi-headed attention block 308.

The output of the direct query decoding manager 112 includes the object token 314 determined by the transformer decoder 306 and the pixel embedding 312 determined by the pixel decoder 302. In some embodiments, the object token 314 for the current frame at time t is stored by the memory manager 114 as a past object token in the set of past object tokens 124 for processing a subsequent frame at a time t+1.

FIG. 4 illustrates an example process of supervised learning used to train the segmentation system in an end-to-end approach, in accordance with one or more embodiments. Training the segmentation system 100 using an end-to-end approach 400 increases the scalability of the segmentation system 100 as the performance of the segmentation system 100 can be increased using new and/or additional training data.

Supervised learning is a method of training a machine learning model given input-output pairs. An input-output pair (e.g., training input 402 and corresponding known output 418) is an input with an associated known output (e.g., an expected output, a labeled output, a ground truth). For example, a training input 402 for the segmentation system 100 can include a frame of a video including one or more objects (e.g., background objects and/or foreground objects). The corresponding known output 418 is a mask of the one or more objects of the frame. For example, a tree in a training dataset may be labeled “object 1” (given a class-agnostic training dataset) or “tree” (given a training dataset with classes) and each instance of the tree, as it appears across the sequence of video frames, is segmented and labeled with “object 1” or “tree” respectively. As a result, the segmentation system 100 learns the semantics of the object as it appears in frames of the video over time.

The segmentation system 100 is trained on known input-output pairs such that the segmentation system can learn how to predict object masks given frames including objects. As described herein, when the segmentation system 100 determines a masked frame, the segmentation system 100 masks objects in the frame by determining the spatial region of objects (e.g., object tokens) based on the spatial identity of past objects (e.g., past object tokens). The background of the past frame (e.g., part of the spatial identity of past object tokens) is a learnable parameter B that is trained during supervised learning of the segmentation system 100.

In operation, the training manager 430 passes a training input 402 to the segmentation system 100 and the segmentation system 100 predicts output 406 using the components of segmentation system 100 (e.g., the instance mask propagation manager 110 and direct query decoding manager 112 described herein). Specifically, one or more nodes of a layer of a machine learning model (e.g., the spatial identity manager 208 and the cross-attention layer 204 of the instance mask propagation manager 110; the pixel decoder 302 and transformer decoder 306 of the direct query decoding manager 112) are applied to the input. A layer can refer to a sub-structure of a machine learning model and includes a number of nodes (e.g., neurons) that perform a particular computation and are interconnected to nodes of adjacent layers. Nodes can be used to sum values from adjacent nodes and apply an activation function, allowing the layer to detect nonlinear patterns. Nodes are interconnected by weights, which are adjusted based on an error determined by comparing the known output 418 to the predicted output 406. The adjustment of the weights during training facilitates the machine learning model's (e.g., the spatial identity manager 208 and the cross-attention layer 204 of the instance mask propagation manager 110; the pixel decoder 302 and transformer decoder 306 of the direct query decoding manager 112) ability to predict a reliable output. The comparator 410 compares the predicted output 406 to the known output 418 to determine a loss (or a difference) between the predicted output 406 and the known output 418.

Conventional segmentation systems can be trained in an end-to-end manner by ignoring mask loss of objects that are not detected in a frame. For example, if an object is in a first frame, a mask loss for the object is computed by comparing the known output 418 to the predicted output 406. If the object is not present in a second frame, then the mask loss for the object is not computed. That is, conventional systems compute mask losses for certain masks (e.g., mask of objects that are present in a given frame).

The training manager 430 adds a new known output 418 for objects that are not in a frame but were present in a previous frame. That is, the training manager 430 imposes an additional constraint on the loss computation for objects that are not detected in a frame but have previously been detected in past frames. For example, if an object is detected in a first frame, the mask loss for the object is computed by comparing the known output 418 to the predicted output 406. If the object is not detected in a second frame, the training manager 430 sets the known output 418 to a zero mask (e.g., a value of zero for each pixel associated with the masked object) and determines the mask loss for the object by comparing the newly generated known output 418 to the predicted output 406. As a result of the mask loss computation for objects that have disappeared after they have been detected, the segmentation system 100 learns to suppress the propagation of redundant masks. That is, the training manager 430 adds more supervision to training the segmentation system 100 using the additional constraint added to the training data (e.g., new known output 418 for objects that have disappeared after they have been detected). Accordingly, pixels associated with objects that are not present in a mask are penalized using the new mask loss computation.

The loss signal 412 is used to adjust the weights of the segmentation system 100 such that after a set of training iterations, the segmentation system 100 converges (e.g., changes or learns) over time to generate an acceptably accurate (e.g., an accuracy satisfies a defined tolerance or confidence level) predicted output 406 using the input-output pairs.

In some embodiments, the segmentation system 100 is trained using the backpropagation algorithm, for instance. The backpropagation algorithm operates by propagating the loss signal 412 through the components of the segmentation system 100 (e.g., the feature extractor 106; the instance mask propagation manager 110 including the spatial identity manager 208 and the cross-attention layer 204; the direct query decoding manager 112 including the pixel decoder 302 and the transformer decoder 306; and the mask compiler 116). The components of the segmentation system 100 can be adapted using the loss signal 412 propagated through the segmentation system 100. For example, the learnable parameter B of the spatial identity manager 208 and the cross-attention layer 204 of the instance mask propagation manager 110 can be updated using the loss signal 412. Specifically, weighting coefficients of the components of the segmentation system 100 (e.g., learnable parameter B of the spatial identity manager 208, query weight matrix W_{Q} of the cross-attention layer 204, a key weight matrix W_{K} of the cross-attention layer 204, and value weight matrix W_{V} of the cross-attention layer 204) are adapted based on the loss signal 412. The loss signal 412 may be calculated each iteration (e.g., each pair of training inputs 402 and associated known outputs 418), batch, and/or epoch and propagated through all of the algorithmic weights of the segmentation system 100, tuning the segmentation system 100 to reduce the amount of error. As a result, the differences between the predicted output 406 and the known output 418 are reduced. The segmentation system 100 may be trained until the loss determined at the comparator 410 is within a certain threshold, or a threshold number of batches, epochs, or training iterations has been reached.

In some embodiments, one or more components of the segmentation system 100 are not trained. That is, the loss signal 412 is not used to modify the weighting coefficients of the components of the segmentation system 100. For example, one or more components of the segmentation system 100 are pretrained (e.g., the pixel decoder 302 and/or the transformer decoder 306 of the direct query decoding manager 112).

The training inputs 402 and corresponding known outputs 418 can be training data obtained from a data store, an upstream process, and the like. While any set of training data can be used to train the segmentation system 100, the training manager 430 imposes the additional loss constraint on the training data (e.g., new known output 418 for objects that have disappeared after they have been detected). As described herein, the loss constraint imposed by the training manager 430 discourages the segmentation system 100 from learning to unnecessarily propagate masks across frames by suppressing false negatives (e.g., suppress the generation of redundant masks). Once the segmentation system 100 learns how to predict known input-output pairs, the segmentation system 100 can operate on unknown inputs (e.g., a frame) to predict an output (e.g., a masked frame including one or more masked objects).

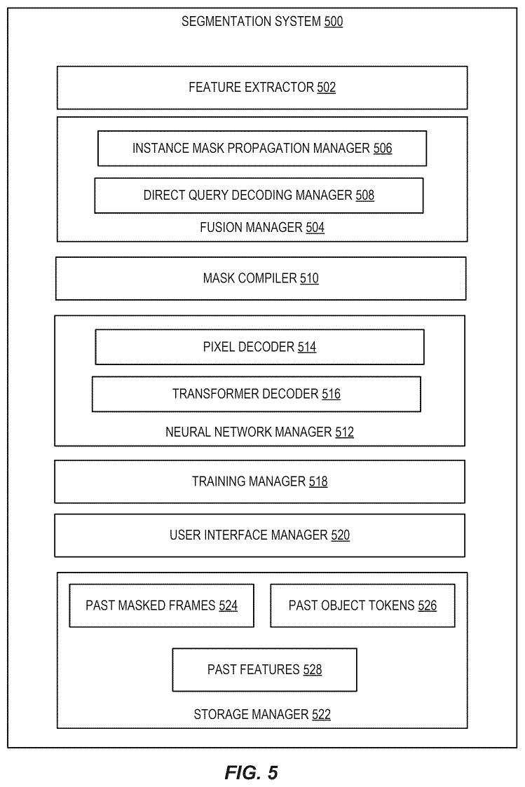

FIG. 5 illustrates a schematic diagram of a segmentation system (e.g., “segmentation system” described above) in accordance with one or more embodiments. As shown, the segmentation system 500 may include, but is not limited to, feature extractor 502, fusion manager 504, mask compiler 510, neural network manager 512, training manager 518, user interface manager 520, and storage manager 522. The fusion manager 504 includes the instance mask propagation manager 506 and the direct query decoding manager 508. The neural network manager 512 includes pixel decoder 514 and transformer decoder 516. The storage manager 522 includes past masked frames 524, past object tokens 526, and past features 528.

As illustrated in FIG. 5, the segmentation system 500 includes a feature extractor 502. The feature extractor 502 can be any machine learning model, such as ResNet, configured to extract one or more features from the frame. Features represent mathematically captured characteristics or properties of the frame. The latent space representation is a space in which unobserved features are determined such that relationships and other dependencies of such features can be learned. The latent space representation may be a feature map (otherwise referred to herein as a feature vector) of extracted properties/characteristics of the frame. In some embodiments, the feature extractor 502 is hosted by the neural network manager 512.

As illustrated in FIG. 5, the segmentation system 500 includes a fusion manager 504. The fusion manager 504 integrates object-level knowledge into dense pixel embeddings using the instance mask propagation manager 506 and the direct query decoding manager 508. The fusion manager 504 combines object-level knowledge (e.g., object tokens) with dense pixel embeddings to determine a masked frame, which includes output mask predictions of each particular object in the frame (e.g., each instance of the frame) and mask classes. The fusion manager 504 leverages the temporal context of objects at a dense pixel-level scale to improve the accuracy and consistency of mask predictions across video frames of a video.

The fusion manager 504 includes an instance mask propagation manager 506. The instance mask propagation manager 506 combines features of the frame with object-aware sparse embeddings (e.g., using the past masked frames 524, past features 528, and past object tokens 526) to calibrate features of the frame with respect to past temporal information. The calibrated feature is a cross-attention of one or more features of the frame with features of past frames (e.g., past features) and an augmented version of the past features. The augmented version of the past features represents objects and the location of objects identified in a past frame, as well as the background of the past frame. The augmented version of the past features is based on past object tokens associated with the corresponding past masked frames and the background of the past frame (e.g., any one or more pixels that are not assigned to a foreground object).

The fusion manager 504 includes a direct query decoding manager 508. The direct query decoding manager 508 uses the calibrated features to generate pixel embeddings for a frame. The pixel embeddings are combined with past object tokens 526 (e.g., past output query embeddings) to generate object tokens for a current frame. The set of object tokens identified in the current frame is a subset of object queries. For example, given a number of object queries that may be present in any given frame, object tokens represent the objects that may be present in the current frame. Both object tokens and object queries can be embeddings.

As illustrated in FIG. 5, the segmentation system 500 includes a mask compiler 510. The mask compiler 510 creates a masked frame that is understandable by humans. For example, the masked frame is a frame that differentiates object instances by masking segmented objects in a way that visually differentiates objects from other objects in the frame. In operation, the mask compiler 510 convolves the object tokens of the current frame with per-pixel embeddings that are based on the calibrated features to generate a probability distribution. The probability distribution indicates a likelihood of each pixel of the frame belonging to a mask (e.g., an instance of an object). The mask compiler 510 converts the probabilities of the probability distribution into a mask displayed to a user. For example, the mask compiler 510 overlays a visual indicator over each pixel belonging to the mask. Such overlayed visual indicators may be colors, patterns, and the like

As illustrated in FIG. 5, the segmentation system 500 includes a neural network manager 512. Neural network manager 512 may host a plurality of neural networks or other machine learning models, such as pixel decoder 514 and transformer decoder 516. The neural network manager 512 may include an execution environment, libraries, and/or any other data needed to execute the machine learning models. In some embodiments, the neural network manager 512 may be associated with dedicated software and/or hardware resources to execute the machine learning models.

As shown, the neural network manager 512 hosts the pixel decoder 514. The pixel decoder 514 can be any machine learning model configured to upscale the low-resolution calibrated features into high-resolution pixel embeddings (e.g., per-pixel embeddings). The pixel decoder 514 receives the calibrated features from the instance mask propagation manager 506, where the calibrated features are a combination of features of the frame with features of past frames (e.g., past features) and an augmented version of the past features (e.g., features representative of the background of the frame).

The neural network manager 512 also hosts the transformer decoder 516. The transformer decoder 516 can be any machine learning model configured to combine object-aware sparse embeddings (e.g., past object tokens) with pixel embeddings to enhance the pixel decoding processing. The transformer decoder 516 uses the pixel-level embeddings determined from the pixel decoder 514 decoding the calibrated features. Accordingly, the object queries for the frame at time t refer to pixel-level embeddings instead of frame-level object embeddings, enhancing the mask prediction ability of the direct query decoding manager 508.

Although depicted in FIG. 5 as being hosted by a single neural network manager 512, in various embodiments the neural networks may be hosted in multiple neural network managers and/or as part of different components. For example, the pixel decoder 514 and the transformer decoder 516 can be hosted by their own neural network manager, or other host environment, in which the respective neural networks execute, or the pixel decoder 514 and the transformer decoder 516 may be spread across multiple neural network managers depending on, e.g., the resource requirements of each machine learning model, etc.

As illustrated in FIG. 5, the segmentation system 500 includes a training manager 518. The training manager 518 can teach, guide, tune, and/or train one or more neural networks. For example, the training manager 518 can use supervised learning in an end-to-end manner to train the components of the segmentation system 500 to generate masks of each instance of an object in a frame of a video sequence using any video instance segmentation training data.

As illustrated in FIG. 5, the segmentation system 500 includes a user interface manager 520. For example, the user interface manager 520 allows users to provide video to the segmentation system 500. In some embodiments, the user interface manager 520 provides a user interface through which the user can upload the input video. Alternatively, or additionally, the user interface may enable the user to download video from a local or remote storage location (e.g., by providing an address (e.g., a URL or other endpoint) associated with a video source). In some embodiments, the user interface can enable a user to link a video capture device, such as a camera or other hardware to capture video data and provide it to the segmentation system 500. The user interface manager 520 enables the user to view the resulting output image and/or request further edits to the image (e.g., remove a highlighted object, select an object, etc.) Additionally, the user interface manager 520 allows users edit the video. For example, the user can highlight an object of the video to be segmented.

As illustrated in FIG. 5, the segmentation system 500 also includes the storage manager 522. The storage manager 522 maintains data for the segmentation system 500. The storage manager 522 can maintain data of any type, size, or kind as necessary to perform the functions of the segmentation system 500. The storage manager 522, as shown in FIG. 5, includes past masked frames 524. Past masked frames 524 are past frames that have been segmented by the segmentation system 500, resulting in masked objects in the past frames (e.g., each instance of the object is masked). As further illustrated in FIG. 5, the storage manager 522 also includes past object tokens 526. Past object tokens 526 are output query embeddings associated with object instances of a past frame determined by the direct query decoding manager 508. In some embodiments, an object token refers to an embedding of an instance of an object in a frame (e.g., a particular object in the frame). As further illustrated in FIG. 5, the storage manager 522 also includes past features 528. Past features 528 include features that have been extracted from past frames (e.g., using feature extractor 502). In some embodiments, the storage manager 522 also stores past frames (not shown).

Each of the components 502, 504, 510, 512, 518, 520, and 522 of the segmentation system 500 and their corresponding elements (as shown in FIG. 5) may be in communication with one another using any suitable communication technologies. It will be recognized that although components and their corresponding elements are shown to be separate in FIG. 5, any of components and their corresponding elements may be combined into fewer components, such as into a single facility or module, divided into more components, or configured into different components as may serve a particular embodiment.

The components and their corresponding elements can comprise software, hardware, or both. For example, the components and their corresponding elements can comprise one or more instructions stored on a computer-readable storage medium and executable by processors of one or more computing devices. When executed by the one or more processors, the computer-executable instructions of the segmentation system 500 can cause a client device and/or a server device to perform the methods described herein. Alternatively, the components and their corresponding elements can comprise hardware, such as a special purpose processing device to perform a certain function or group of functions. Additionally, the components and their corresponding elements can comprise a combination of computer-executable instructions and hardware.

Furthermore, the components of the segmentation system 500 may, for example, be implemented as one or more stand-alone applications, as one or more modules of an application, as one or more plug-ins, as one or more library functions or functions that may be called by other applications, and/or as a cloud-computing model. Thus, the components of the segmentation system 500 may be implemented as a stand-alone application, such as a desktop or mobile application. Furthermore, the components of the segmentation system 500 may be implemented as one or more web-based applications hosted on a remote server. Alternatively, or additionally, the components of the segmentation system 500 may be implemented in a suite of mobile device applications or “apps.”

As shown, the segmentation system 500 can be implemented as a single system. In other embodiments, the segmentation system 500 can be implemented in whole, or in part, across multiple systems. For example, one or more functions of the segmentation system 500 can be performed by one or more servers, and one or more functions of the segmentation system 500 can be performed by one or more client devices. The one or more servers and/or one or more client devices may generate, store, receive, and transmit any type of data used by the segmentation system 500, as described herein.

In one implementation, the one or more client devices can include or implement at least a portion of the segmentation system 500. In other implementations, the one or more servers can include or implement at least a portion of the segmentation system 500. For instance, the segmentation system 500 can include an application running on the one or more servers or a portion of the segmentation system 500 can be downloaded from the one or more servers. Additionally or alternatively, the segmentation system 500 can include a web hosting application that allows the client device(s) to interact with content hosted at the one or more server(s).

For example, upon a client device accessing a webpage or other web application hosted at the one or more servers, in one or more embodiments, the one or more servers can provide access to a user interface displayed at a client device. The client device can prompt a user for a video. Upon receiving the video, the client device can provide the video to the one or more servers, which can automatically perform the methods and processes described herein to segment objects in frames, masking the objects in each frame of the video. The one or more servers can then provide access to the user interface displayed at the client device to display the video including segmented objects.

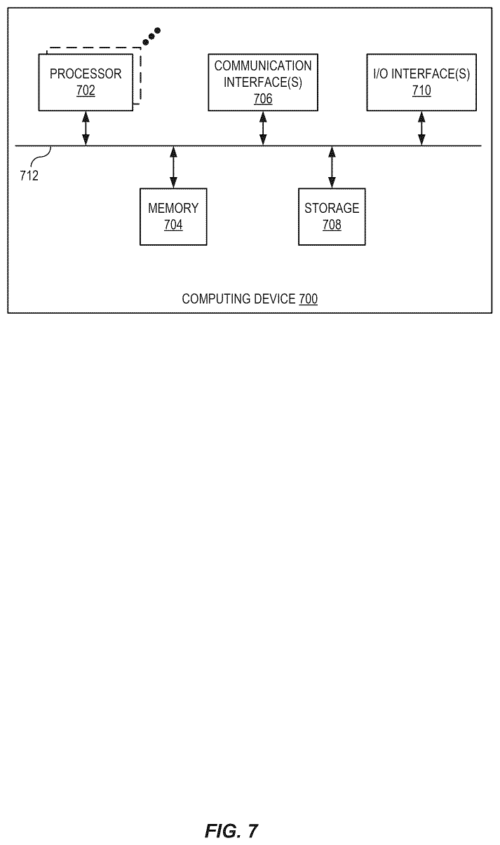

The server(s) and/or client device(s) may communicate using any communication platforms and technologies suitable for transporting data and/or communication signals, including any known communication technologies, devices, media, and protocols supportive of remote data communications, examples of which will be described in more detail below with respect to FIG. 7. In some embodiments, the server(s) and/or client device(s) communicate via one or more networks. A network may include a single network or a collection of networks (such as the Internet, a corporate intranet, a virtual private network (VPN), a local area network (LAN), a wireless local network (WLAN), a cellular network, a wide area network (WAN), a metropolitan area network (MAN), or a combination of two or more such networks. The one or more networks will be discussed in more detail below with regard to FIG. 7.

The server(s) may include one or more hardware servers (e.g., hosts), each with its own computing resources (e.g., processors, memory, disk space, networking bandwidth, etc.) which may be securely divided between multiple customers (e.g. client devices), each of which may host their own applications on the server(s). The client device(s) may include one or more personal computers, laptop computers, mobile devices, mobile phones, tablets, special purpose computers, TVs, or other computing devices, including computing devices described below with regard to FIG. 7.

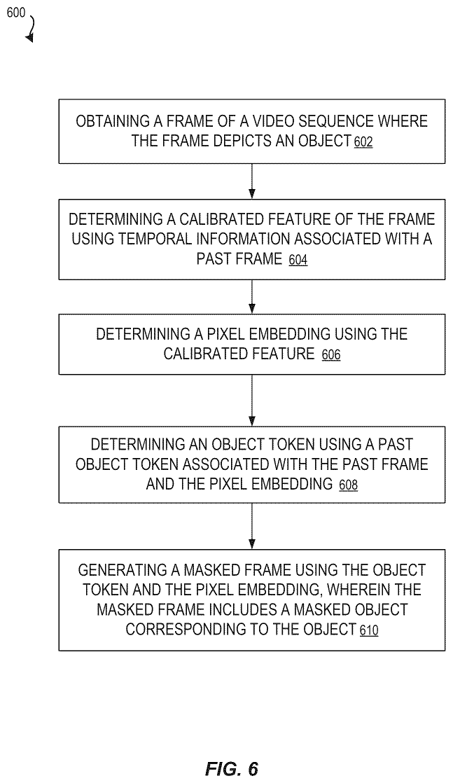

FIGS. 1-5, the corresponding text, and the examples, provide a number of different systems and devices that allows a user to perform video segmentation. In addition to the foregoing, embodiments can also be described in terms of flowcharts comprising acts and steps in a method for accomplishing a particular result. For example, FIG. 6 illustrates a flowchart of an exemplary method in accordance with one or more embodiments. The method described in relation to FIG. 6 may be performed with fewer or more steps/acts or the steps/acts may be performed in differing orders. Additionally, the steps/acts described herein may be repeated or performed in parallel with one another or in parallel with different instances of the same or similar steps/acts.

FIG. 6 illustrates a flowchart 600 of a series of acts in a method of performing video instance segmentation to mask objects across frames of a video, in accordance with one or more embodiments. In one or more embodiments, the method 600 is performed in a digital medium environment that includes the segmentation system 500. The method 600 is intended to be illustrative of one or more methods in accordance with the present disclosure and is not intended to limit potential embodiments. Alternative embodiments can include additional, fewer, or different steps than those articulated in FIG. 6.

As illustrated in FIG. 6, the method 600 includes an act 602 of obtaining a frame of a video sequence where the frame depicts an object. The frame is an instantaneous image of the video sequence at a time t. The video sequence can include any digital visual media including a plurality of frames which, when played, includes a moving visual representation of a story and/or an event. The frame depicts one or more objects. Each object of the frame can be referred to as an instance.

As illustrated in FIG. 6, the method 600 includes an act 604 of determining a calibrated feature of the frame using temporal information associated with a past frame. A feature represents mathematically captured characteristics or properties of a frame. The latent space representation is a space in which unobserved features are determined such that relationships and other dependencies of such features can be learned. The latent space representation may be a feature map (otherwise referred to herein as a feature vector) of extracted properties/characteristics of the frame. A calibrated feature is a combination of one or more features of the frame with features of past frames (e.g., past features) and an augmented version of the past features. The augmented version of the past features represents objects and the location of objects identified in a past frame, as well as the background of the past frame. The augmented version of the past features is based on past object tokens associated with the corresponding past masked frames and the background of the past frame (e.g., any one or more pixels that are not assigned to a foreground object).

As illustrated in FIG. 6, the method 600 includes an act 606 of determining a pixel embedding using the calibrated feature. The calibrated feature is transformed from a low-resolution feature vector to a high-resolution pixel embedding using any suitable machine learning model configured to upscale features. Because the calibrated feature includes temporal information from previous frames, the pixel embeddings include temporal information.

As illustrated in FIG. 6, the method 600 includes an act 608 of determining an object token using a past object token associated with the past frame and the pixel embedding. Because object tokens are based on pixel embeddings, which are based on calibrated features, the object tokens stored in memory (e.g., past object tokens) are past object tokens combined with temporal information. Using the pixel embeddings and the past object tokens to determine an object token of a frame improves coherency at the pixel-level because the propagated object embeddings (e.g., past object tokens) reference the pixel embeddings of the frame.

As illustrated in FIG. 6, the method 600 includes an act 610 of generating a masked frame using the object token and the pixel embedding, wherein the masked frame includes a masked object corresponding to the object. The object tokens of the frame (e.g., object queries) can be convolved with per-pixel embeddings that are based on the calibrated features to generate a probability distribution. The probability distribution indicates a likelihood of each pixel of the frame belonging to a mask (e.g., an instance of an object). The probabilities of the probability distribution are converted into a mask displayed to a user. For example, if a probability associated with a pixel satisfies a threshold probability, the pixel associated with the probability is masked (e.g., overlaid with a visual indicator).

Embodiments of the present disclosure may comprise or utilize a special purpose or general-purpose computer including computer hardware, such as, for example, one or more processors and system memory, as discussed in greater detail below. Embodiments within the scope of the present disclosure also include physical and other computer-readable media for carrying or storing computer-executable instructions and/or data structures. In particular, one or more of the processes described herein may be implemented at least in part as instructions embodied in a non-transitory computer-readable medium and executable by one or more computing devices (e.g., any of the media content access devices described herein). In general, a processor (e.g., a microprocessor) receives instructions, from a non-transitory computer-readable medium, (e.g., a memory, etc.), and executes those instructions, thereby performing one or more processes, including one or more of the processes described herein.

Computer-readable media can be any available media that can be accessed by a general purpose or special purpose computer system. Computer-readable media that store computer-executable instructions are non-transitory computer-readable storage media (devices). Computer-readable media that carry computer-executable instructions are transmission media. Thus, by way of example, and not limitation, embodiments of the disclosure can comprise at least two distinctly different kinds of computer-readable media: non-transitory computer-readable storage media (devices) and transmission media.

Non-transitory computer-readable storage media (devices) includes RAM, ROM, EEPROM, CD-ROM, solid state drives (“SSDs”) (e.g., based on RAM), Flash memory, phase-change memory (“PCM”), other types of memory, other optical disk storage, magnetic disk storage or other magnetic storage devices, or any other non-transitory storage medium which can be used to store desired program code means in the form of computer-executable instructions or data structures and which can be accessed by a general purpose or special purpose computer.

A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmissions media can include a network and/or data links which can be used to carry desired program code means in the form of computer-executable instructions or data structures and which can be accessed by a general purpose or special purpose computer. Combinations of the above should also be included within the scope of computer-readable media.

Further, upon reaching various computer system components, program code means in the form of computer-executable instructions or data structures can be transferred automatically from transmission media to non-transitory computer-readable storage media (devices) (or vice versa). For example, computer-executable instructions or data structures received over a network or data link can be buffered in RAM within a network interface module (e.g., a “NIC”), and then eventually transferred to computer system RAM and/or to less volatile computer storage media (devices) at a computer system. Thus, it should be understood that non-transitory computer-readable storage media (devices) can be included in computer system components that also (or even primarily) utilize transmission media.

Computer-executable instructions comprise, for example, instructions and data which, when executed at a processor, cause a general-purpose computer, special purpose computer, or special purpose processing device to perform a certain function or group of functions. In some embodiments, computer-executable instructions are executed on a general-purpose computer to turn the general-purpose computer into a special purpose computer implementing elements of the disclosure. The computer executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the disclosure may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, tablets, pagers, routers, switches, and the like. The disclosure may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

Embodiments of the present disclosure can also be implemented in cloud computing environments. In this description, “cloud computing” is defined as a model for enabling on-demand network access to a shared pool of configurable computing resources. For example, cloud computing can be employed in the marketplace to offer ubiquitous and convenient on-demand access to the shared pool of configurable computing resources. The shared pool of configurable computing resources can be rapidly provisioned via virtualization and released with low management effort or service provider interaction, and then scaled accordingly.

A cloud-computing model can be composed of various characteristics such as, for example, on-demand self-service, broad network access, resource pooling, rapid elasticity, measured service, and so forth. A cloud-computing model can also expose various service models, such as, for example, Software as a Service (“SaaS”), Platform as a Service (“PaaS”), and Infrastructure as a Service (“IaaS”). A cloud-computing model can also be deployed using different deployment models such as private cloud, community cloud, public cloud, hybrid cloud, and so forth. In this description and in the claims, a “cloud-computing environment” is an environment in which cloud computing is employed.

FIG. 7 illustrates, in block diagram form, an exemplary computing device 700 that may be configured to perform one or more of the processes described above. One will appreciate that one or more computing devices such as the computing device 700 may implement the segmentation system. As shown by FIG. 7, the computing device can comprise a processor 702, memory 704, one or more communication interfaces 706, a storage device 708, and one or more I/O devices/interfaces 710. In certain embodiments, the computing device 700 can include fewer or more components than those shown in FIG. 7. Components of computing device 700 shown in FIG. 7 will now be described in additional detail.

In particular embodiments, processor(s) 702 includes hardware for executing instructions, such as those making up a computer program. As an example, and not by way of limitation, to execute instructions, processor(s) 702 may retrieve (or fetch) the instructions from an internal register, an internal cache, memory 704, or a storage device 708 and decode and execute them. In various embodiments, the processor(s) 702 may include one or more central processing units (CPUs), graphics processing units (GPUs), field programmable gate arrays (FPGAs), systems on chip (SoC), or other processor(s) or combinations of processors.

The computing device 700 includes memory 704, which is coupled to the processor(s) 702. The memory 704 may be used for storing data, metadata, and programs for execution by the processor(s). The memory 704 may include one or more of volatile and non-volatile memories, such as Random Access Memory (“RAM”), Read Only Memory (“ROM”), a solid state disk (“SSD”), Flash, Phase Change Memory (“PCM”), or other types of data storage. The memory 704 may be internal or distributed memory.

The computing device 700 can further include one or more communication interfaces 706. A communication interface 706 can include hardware, software, or both. The communication interface 706 can provide one or more interfaces for communication (such as, for example, packet-based communication) between the computing device and one or more other computing devices 700 or one or more networks. As an example and not by way of limitation, communication interface 706 may include a network interface controller (NIC) or network adapter for communicating with an Ethernet or other wire-based network or a wireless NIC (WNIC) or wireless adapter for communicating with a wireless network, such as a WI-FI. The computing device 700 can further include a bus 712. The bus 712 can comprise hardware, software, or both that couples components of computing device 700 to each other.

The computing device 700 includes a storage device 708 includes storage for storing data or instructions. As an example, and not by way of limitation, storage device 708 can comprise a non-transitory storage medium described above. The storage device 708 may include a hard disk drive (HDD), flash memory, a Universal Serial Bus (USB) drive or a combination these or other storage devices. The computing device 700 also includes one or more input or output (“I/O”) devices/interfaces 710, which are provided to allow a user to provide input to (such as user strokes), receive output from, and otherwise transfer data to and from the computing device 700. These I/O devices/interfaces 710 may include a mouse, keypad or a keyboard, a touch screen, camera, optical scanner, network interface, modem, other known I/O devices or a combination of such I/O devices/interfaces 710. The touch screen may be activated with a stylus or a finger.

The I/O devices/interfaces 710 may include one or more devices for presenting output to a user, including, but not limited to, a graphics engine, a display (e.g., a display screen), one or more output drivers (e.g., display drivers), one or more audio speakers, and one or more audio drivers. In certain embodiments, I/O devices/interfaces 710 is configured to provide graphical data to a display for presentation to a user. The graphical data may be representative of one or more graphical user interfaces and/or any other graphical content as may serve a particular implementation.

In the foregoing specification, embodiments have been described with reference to specific exemplary embodiments thereof. Various embodiments are described with reference to details discussed herein, and the accompanying drawings illustrate the various embodiments. The description above and drawings are illustrative of one or more embodiments and are not to be construed as limiting. Numerous specific details are described to provide a thorough understanding of various embodiments.

Embodiments may include other specific forms without departing from its spirit or essential characteristics. The described embodiments are to be considered in all respects only as illustrative and not restrictive. For example, the methods described herein may be performed with less or more steps/acts or the steps/acts may be performed in differing orders. Additionally, the steps/acts described herein may be repeated or performed in parallel with one another or in parallel with different instances of the same or similar steps/acts. The scope of the invention is, therefore, indicated by the appended claims rather than by the foregoing description. All changes that come within the meaning and range of equivalency of the claims are to be embraced within their scope.

In the various embodiments described above, unless specifically noted otherwise, disjunctive language such as the phrase “at least one of A, B, or C,” is intended to be understood to mean either A, B, or C, or any combination thereof (e.g., A, B, and/or C). As such, disjunctive language is not intended to, nor should it be understood to, imply that a given embodiment requires at least one of A, at least one of B, or at least one of C to each be present.

We claim:

1. A method comprising:
obtaining a frame of a video sequence, wherein the frame depicts an object;
determining a calibrated feature of the frame using temporal information associated with a past frame;
determining a pixel embedding using the calibrated feature;
determining an object token using a past object token associated with the past frame and the pixel embedding; and
generating a masked frame using the object token and the pixel embedding, wherein the masked frame includes a masked object corresponding to the object.

2. The method of claim 1, wherein determining the calibrated feature of the frame using temporal information associated with the past frame further comprises:
determining a spatial identity of an object of the past frame using a past masked frame and a past object token.

3. The method of claim 2, wherein determining the calibrated feature of the frame using temporal information associated with the past frame further comprises:
combining the spatial identity, a feature of the frame, and a feature of the past frame.

4. The method of claim 2, wherein the spatial identity includes a background of the past frame.

5. The method of claim 4, wherein the background of the past frame is a parameter that is learned during end-to-end supervised learning.

6. The method of claim 1, wherein generating the masked frame using the object token and the pixel embedding further comprises:
convolving the object token with the pixel embedding to generate a probability distribution, wherein the probability distribution indicates a likelihood of each pixel of the frame belonging to the masked object.

7. The method of claim 1, wherein the masked frame comprises one or more masked objects.

8. A non-transitory computer-readable medium storing executable instructions, which when executed by a processing device, cause the processing device to perform operations comprising:
obtaining a frame of a video sequence, wherein the frame depicts an object;
determining a calibrated feature of the frame using temporal information associated with a past frame;
determining a pixel embedding using the calibrated feature;
determining an object token using a past object token associated with the past frame and the pixel embedding; and
generating a masked frame using the object token and the pixel embedding, wherein the masked frame includes a masked object corresponding to the object.

9. The non-transitory computer-readable medium of claim 8, wherein determining the calibrated feature of the frame using temporal information associated with the past frame further includes instructions that further cause the processing device to perform operations comprising:
determining a spatial identity of an object of the past frame using a past masked frame and a past object token.

10. The non-transitory computer-readable medium of claim 9, wherein determining the calibrated feature of the frame using temporal information associated with the past frame further includes instructions that further cause the processing device to perform operations comprising:
combining the spatial identity, a feature of the frame, and a feature of the past frame.

11. The non-transitory computer-readable medium of claim 9, wherein the spatial identity includes a background of the past frame.

12. The non-transitory computer-readable medium of claim 11, wherein the background of the past frame is a parameter that is learned during end-to-end supervised learning.

13. The non-transitory computer-readable medium of claim 8, wherein generating the masked frame using the object token and the pixel embedding further includes instructions that further cause the processing device to perform operations comprising:
convolving the object token with the pixel embedding to generate a probability distribution, wherein the probability distribution indicates a likelihood of each pixel of the frame belonging to the masked object.

14. The non-transitory computer-readable medium of claim 8, wherein the masked frame comprises one or more masked objects.

15. A system comprising:
a memory component; and
a processing device coupled to the memory component, the processing device to perform operations comprising:
obtaining a frame of a video sequence, wherein the frame depicts an object;
determining frame features using the frame;
generating a spatial identity of a previous frame using a mask of a previous frame and an embedding of the object depicted in the previous frame;
generating an augmented spatial identity using the spatial identity and encoding a background of the previous frame; and
generating a masked frame using a pixel embedding and an embedding of the object depicted in the frame, wherein the pixel embedding is based on the augmented spatial identity and the frame features.

16. The system of claim 15, wherein the processing device performs further operations comprising:
determining the embedding of the object depicted in the frame using the object depicted in the previous frame and the pixel embedding.

17. The system of claim 15, wherein the masked frame includes a masked object corresponding to the object.

18. The system of claim 15, wherein encoding the background of the previous frame is learned during end-to-end supervised learning.

19. The system of claim 15, wherein generating the masked frame using the pixel embedding and the embedding of the object depicted in the frame includes the processing device performing further operations comprising:
convolving the embedding of the object depicted in the frame with the pixel embedding to generate a probability distribution, wherein the probability distribution indicates a likelihood of each pixel of the frame belonging to a masked object of the masked frame.

20. The system of claim 15, wherein the masked frame comprises one or more masked objects.
